(19) United States
(12) Patent Application Publication
(10) Pub. No.: US 2025/0283615 A1
(43) Pub. Date: Sep. 11, 2025

(54) WINDOW KIT OF AIR CONDITIONER

(71) Applicant: LG ELECTRONICS INC., Seoul (KR)

(72) Inventors: Taegwon HA, Seoul (KR); Hyuncheol Park, Seoul (KR); Daekwon Jeong, Seoul (KR); Moohee Kim, Seoul (KR)

(21) Appl. No.: 18/817,450

(22) Filed: Aug. 28, 2024

(30) Foreign Application Priority Data
Mar. 6, 2024 (KR) 10-2024-0032281

(51) Int. Cl. F24F 1/04; F24F 1/027

(52) U.S. Cl. CPC F24F 1/04; F24F 1/027; F24F 2221/20

(57) ABSTRACT

A window kit of an air conditioner is provided. The window kit of an air conditioner is configured to be mounted on a window frame connected to a casement window and coupled with an exhaust guide that extends from an exhaust port of a mobile air conditioner. The window kit may include a first installation member configured to be mounted between a rotating end portion of the casement window and the window frame and including an insertion hole into which a nozzle of the exhaust guide is configured to be inserted, and a second installation member coupled to one end portion of the first installation member and mounted on the window frame. The first installation member is configured to have a variable length. The second installation member may include a base part or portion coupled to the first installation member, and a plurality of variable parts or portions detachably connected to an upper end of the base portion.

### CROSS-REFERENCE TO RELATED APPLICATION(S)

This application claims priority under 35 U.S.C. § 119 to Korean Application No. KR 10-2024-0032281 filed in Korea on Mar. 6, 2024, whose entire disclosure is hereby incorporated by reference.

### BACKGROUND

### 1. Field

A window kit for an air conditioner is disclosed herein.

### 2. Background

In general, an air conditioner is a cooling/heating system that cools or heats a room by repeatedly suctioning in indoor air, exchanging heat with a low-temperature or high-temperature refrigerant, and then discharging the air into the room. The air conditioner performs a series of cycles including a compressor, an outdoor heat exchanger, an expansion valve, and an evaporator.

Air conditioners generally include two types, separate air conditioners, in which an indoor unit and an outdoor unit are separated, and integrated air conditioners, in which the indoor unit and the outdoor unit are combined. The separate air conditioner includes an outdoor unit that is mainly installed outdoors (sometimes referred to as the ‘outdoor side’ or ‘heat dissipation side’) and an indoor unit that is mainly installed inside of a building (sometimes referred to as the ‘indoor side’ or ‘heat absorption side’). An outdoor heat exchanger and a compressor are installed in the outdoor unit, and an evaporator is installed in the indoor unit.

The integrated air conditioner is a type in which an indoor unit and an outdoor unit are combined, and an indoor heat exchanger and an outdoor heat exchanger are provided in one main body, so that the entire air conditioner is installed in one main body. In addition, the integrated air conditioner may be classified into a fixed air conditioner that is fixedly installed on a window, or a window frame, for example, and a mobile air conditioner, a main body of which may be moved to a required space and discharge heat-exchanged air to the outside through an exhaust guide means.

Among these air conditioners, the mobile air conditioner may be configured to have an exhaust guide means fixed to a window to discharge heat-exchanged air to the outside. The exhaust guide means of the mobile air conditioner may be fixed to the window to ensure stable air discharge.

### BRIEF DESCRIPTION OF THE DRAWINGS

Embodiments will be described in detail with reference to the following drawings in which like reference numerals refer to like elements, and wherein:

FIG. 1 is a perspective view illustrating a state in which an exhaust guide means of a mobile air conditioner is coupled to a window kit of an air conditioner according to an embodiment;

FIG. 2 is a perspective view illustrating a state in which a window kit of an air conditioner is installed on a casement window according to an embodiment;

FIG. 3 is an exploded perspective view of a window kit of an air conditioner according to an embodiment;

FIG. 4 is a plan view of a first installation member of a window kit of an air conditioner according to an embodiment;

FIG. 5 is a cross-sectional view, taken along line V-V of FIG. 4;

FIG. 6 is a perspective view of a second installation member and a third installation member of the window kit of an air conditioner according to an embodiment;

FIG. 7 is an enlarged perspective view of area A of FIG. 2;

FIG. 8 is an enlarged perspective view of area B of FIG. 2;

FIG. 9 is a cross-sectional view, taken along line IX-IX of FIG. 1;

FIG. 10 is a cross-sectional view, taken along line X-X of FIG. 9;

FIG. 11 is an enlarged perspective view of area C in FIG. 2;

FIG. 12 is a cross-sectional view, taken along line XII-XII of FIG. 11;

FIG. 13 is a cross-sectional view, taken along line XIII-XIII of FIG. 11;

FIG. 14 is a view of a modified window kit of an air conditioner according to an embodiment installed on a window of a different size from the window of FIG. 1;

FIG. 15 is a view of a window kit of an air conditioner according to another embodiment;

FIG. 16 is a view of a window kit of an air conditioner according to another embodiment; and

FIG. 17 is a cross-sectional view, taken along line XVII-XVII of FIG. 16.

### DETAILED DESCRIPTION

Hereinafter, embodiments will be described with reference to the drawings. However, the embodiments cannot be said to be limited to the embodiments in which the idea is presented, and other embodiments that are regressive or other embodiments included within the scope may be easily suggested by adding, changing, or deleting other components.

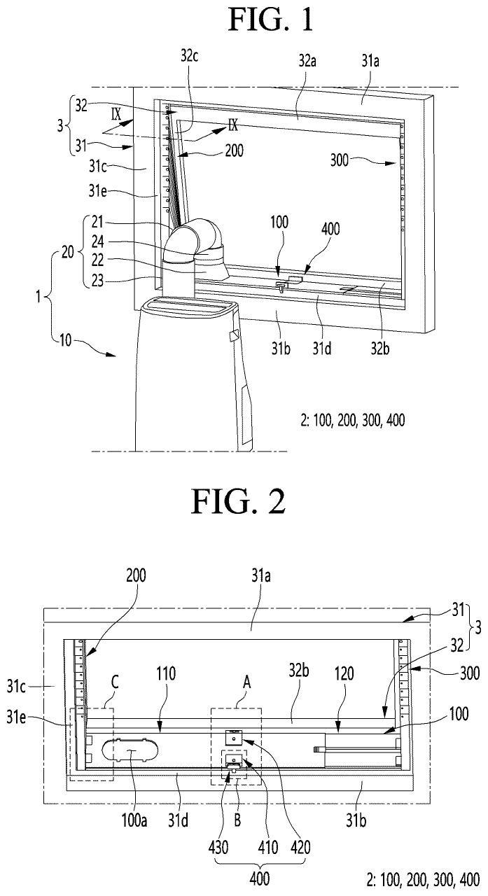

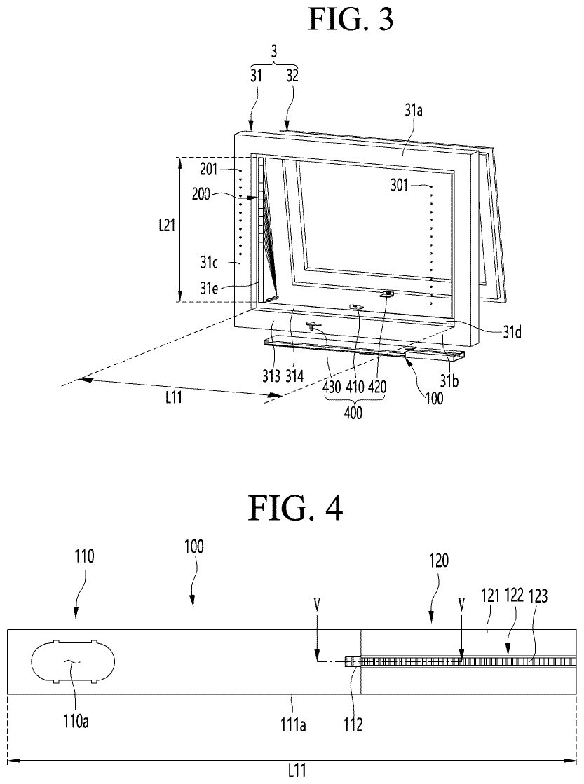

FIG. 1 is a perspective view illustrating a state in which an exhaust guide means of a mobile air conditioner is coupled to a window kit of an air conditioner according to an embodiment. FIG. 2 is a perspective view illustrating a state in which a window kit of an air conditioner is installed on a casement window according to an embodiment. FIG. 3 is an exploded perspective view of a window kit of an air conditioner according to an embodiment.

Referring to FIGS. 1 to 3, air conditioner 1 according to an embodiment may include a main body 10 and an exhaust guide means 20 configured to discharge heat-exchanged air from the main body 10 outside (in particular outdoors). As illustrated, the air conditioner 1 according to an embodiment is an integrated air conditioner in which an indoor unit and an outdoor unit are combined, and in which an indoor heat exchanger and an outdoor heat exchanger may be provided in one main body 10.

The air conditioner 1 according to an embodiment may be a mobile air conditioner, that is, the main body 10 may be moved to a required space and discharge heat-exchanged air to the outside through the exhaust guide means 20. The exhaust guide means 20 of the mobile air conditioner 1 may be fixed to a window for stable air discharge and configured to discharge heat-exchanged air to the outside.

Components forming a refrigeration cycle may be built into the main body 10. For example, the main body 10 may be equipped with an evaporator, a heat exchanger that functions as a condenser, a compressor, an expansion device, and a fan/fan motor for air flow. Although not illustrated, the main body 10 may be formed with a suction port through which indoor air is suctioned in and a discharge port through which heat-exchanged air is discharged into a room. Additionally, an exhaust port through which air is discharged to the outdoors may be formed in the main body 10, and the exhaust guide means 20 may be mounted on the exhaust port.

The air in a room in which the main body 10 is located may be suctioned in from the suction port, exchange heat with a heat exchanger inside of the main body 10, and then be discharged into an indoor space through the discharge port. In addition, air that has passed through the heat exchanger and exchanged heat may pass through the exhaust port and be discharged to the outdoor space by the exhaust guide means 20. This action makes it possible to cool or heat the indoor space.

The exhaust guide means 20 is configured to guide a flow of exhausted air by connecting the exhaust port of the main body to a window kit 2 installed on a window frame. The exhaust guide means 20 may include an exhaust pipe 21 forming an air flow path, a nozzle 22 connected to a first installation member 100 at an end portion of the exhaust pipe 21, a main body connector 23, and a nozzle connector 24.

The exhaust pipe 21 may have a hollow tube shape and be flexible enough to be bent according to a position and height of a window to which the exhaust guide means 20 is connected. Therefore, the exhaust pipe 21 may extend lengthwise and may be made of a flexible plastic, for example. Additionally, the exhaust pipe 21 may be configured to maintain an original shape thereof even when bent as illustrated in the drawing.

The nozzle 22 may be combined or coupled with the first installation member 100, which will be described hereinafter, to fix the exhaust guide means 20, and to allow the discharged air to be completely discharged outdoors. The nozzle 22 may be made of a plastic material, for example, and may be coupled to the first installation member 100.

The main body connector 23 may be provided between the main body 10 and the exhaust pipe 21 to guide a lower end of the exhaust pipe 21 to be mounted on the main body 10. The nozzle connector 24 may be provided between the exhaust pipe 21 and the nozzle 22 to allow the nozzle 22 to be fastened to an upper end of the exhaust pipe 21.

The window kit 2 of the air conditioner according to an embodiment may be provided to fix the nozzle 22 of the exhaust guide means 20 to a casement window 3. The casement window 3 may include a window frame 31 and a window 32.

The window kit 2 of the air conditioner according to an embodiment may be installed on the window frame 31 and the window 32. For example, the window 32 may be configured to open and close an opening of the window frame 31 by opening and closing the window frame 31 through rotation. In one embodiment, the window 32 may include a fixed end portion 32a forming a rotational axis, a rotating end portion 32b located on an opposite side of the fixed end portion 32a and moving in an arc when the window 32 is opened and closed, and a side end portion 32c that connects the fixing end portion 32a and the rotating end portion 32b.

Correspondingly, the window frame 31 may include a first frame part or portion 31a corresponding to the fixed end portion 32a, a second frame part or portion 31b corresponding to the rotating end portion 32b, and a third frame part or portion 31c corresponding to the side end portion 32c. The window frame 31 may further include a first window frame rib 31d that protrudes inside of the second frame portion 31b and a second window frame rib 31e that protrudes inside of the third frame portion 31c. The first installation member 100 may be fixed to the first window frame rib 31d. Second and third installation members 200 and 300 may be fixed to the second window frame rib 31e.

The first window frame rib 31d, illustrated in FIG. 3, may have a first length L11, and the second window frame rib 31e may have a second length L21. Referring to FIG. 14, which will be described hereinafter, when sizes of the first window frame rib 31d and the second window frame rib 31e are changed, it will be explained that window kit 2 according to another embodiment may be structurally changed.

In this embodiment, the first frame portion 31a corresponding to the fixed end portion 32a constitutes an upper end portion of the window frame 31, and the rotating end portion 32b is explained based on structure of the window 32 that opens and closes toward an indoor side; however, embodiments are not limited thereto and may also be applied to a window having a different type of casement structure. For example, this embodiment may also be applied to structure in which the first frame portion 31a constitutes the lower end portion or both side portions of the window frame, and may be also applied to structure of a window in which the rotating end portion 32b opens and closes toward the outside.

The window kit 2 of the air conditioner 1 may be fixed to the window frame 31 and the window 32. The window kit 2 of the air conditioner 1 may include first installation member 100 fixed to the rotating end portion 32b of the window 32 and the first window frame rib 31d, second and third installation members 200, 300 coupled to both end portions of the first installation member 100 and fixed to the second window frame rib 31e, and a fixing member 400 configured to fix the first installation member 100 to the rotating end portion 32b of the window 32 and the first window frame rib 31d.

The first installation member 100 may be fixed to the window frame 31 and the window 32 and may be connected to the exhaust guide means 20. For example, one or a first side of the first installation member 100 may be coupled to the first window frame rib 31d, and the other or a second side thereof may be coupled to the rotating end portion 32b of the window 32.

The first installation member 100 may include an installation panel 110 to which the exhaust guide means 20 may be connected, and a sliding panel 120 that is coupled to the installation panel 110 and slides in and out in a longitudinal direction of the installation panel 110. Through the structure of the sliding panel 120 configured to slide in and out with respect to the installation panel 110, a length of the first installation member 100 may be set in various ways according to a length of the rotating end portion 32b and the second frame portion 31b of the installed window 32.

An insertion hole 110a into which the nozzle 22 may be inserted may be formed in the installation panel 110, and an end portion of the nozzle 22 may penetrate the insertion hole 110a. Additionally, upper and lower ends of the installation panel 110 may be bent so that the sliding panel 120 may be slidably coupled to the installation panel 110.

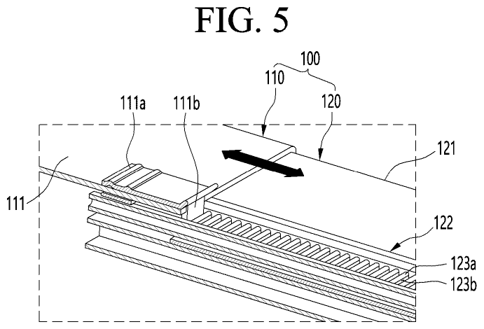

Structure of the first installation member 100 will be described hereinafter with reference to FIGS. 4 and 5.

The second and third installation members 200 and 300 may be coupled to both end portions of the first installation member 100 in an extension direction, respectively. For example, the second installation member 200 may be coupled to one or a first end portion of the first installation member 100, and the third installation member 300 may be coupled to the other or a second end portion of the first installation member 100. The second installation member 200 and the third installation member 300 may have a symmetrical structure.

The second installation member 200 may be fastened to the second window frame rib 31e on one or a first side through a first fastening member 201, and the third installation member 300 may be fastened to the second window frame rib 31e on the other or a second side through a second fastening member 301.

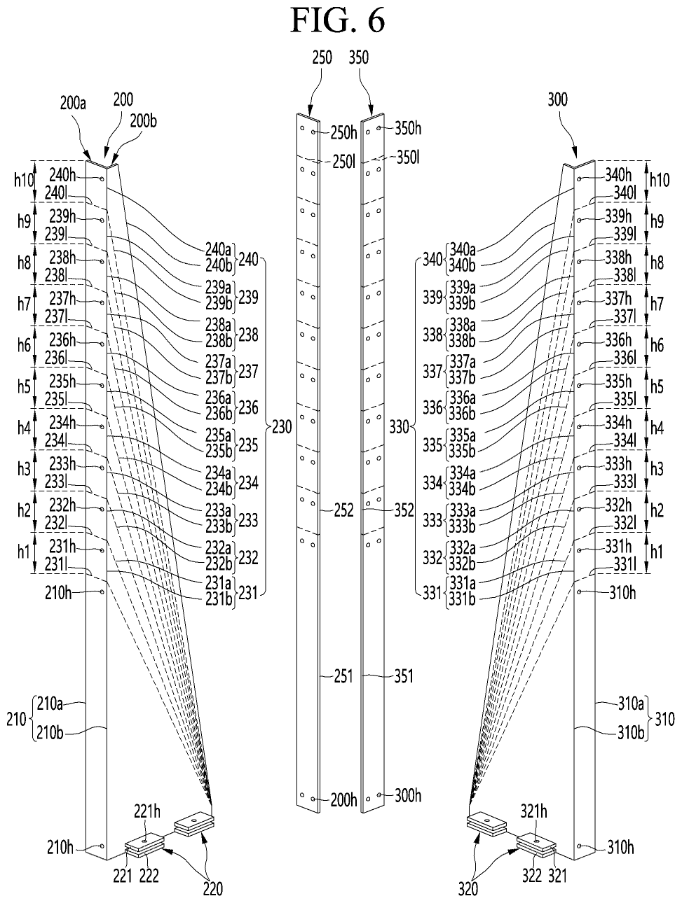

Structures of the second and third installation members 200 and 300 will be described hereinafter with reference to FIG. 6.

The fixing member 400 may fix the first installation member 100 to the window frame 31 and the window 32. For example, the first installation member 100 may be fixed to the second frame portion 31b and the first window frame rib 31d. The fixing member 400 does not cause damage, such as perforations, to the first window frame rib 31d, and may fix the first installation member 100 to the first window frame rib 31d.

The fixing member 400 included in the window kit 2 of the air conditioner according to an embodiment may be located in a place in which it may be easily fixed in the room. Therefore, the window kit 2 may be easily fixed to or separated from the casement window 3.

The fixing member 400 may include a first fixing member 410, which may be fixed to an inner end of the first installation member 100, a second fixing member 420 fixed to an outer end of the first installation member 100, and at the same time, fixed to the rotating end portion of the window 32, and a restraining member 430 rotatably connected to the first fixing member 410 to restrain or fix the first fixing member 410 to the first window frame rib 31d. The first fixing member 410 may be coupled to the first installation member 100, and the restraining member 430 may restrain or fix the first fixing member 410 to the first window frame rib 31d, and thus, the fixing member 400 according to an embodiment may fix the first installation member 100 to the first window frame rib 31d without causing damage, such as perforations, to the first window frame rib 31d.

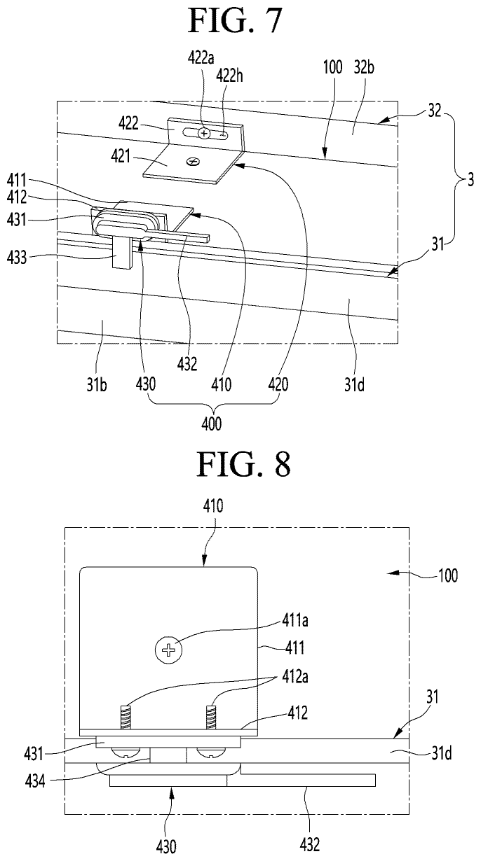

Fixing the first installation member 100 using the fixing member 400 will be described hereinafter with reference to FIGS. 7 and 8.

FIG. 4 is a plan view of a first installation member of a window kit of an air conditioner according to an embodiment. FIG. 5 is a cross-sectional view, taken along line V-V of FIG. 4.

Referring to FIGS. 4 and 5, the first installation member 100 may include the installation panel 110 including the insertion hole 110a into which the nozzle 22 of the exhaust guide means 20 is inserted and the sliding panel 120 that is slid in and out in the longitudinal direction of the installation panel 110. The installation panel 110 may include a plate-shaped first panel part or portion 111 having a predetermined width and a restraining part or portion 111a disposed on one side of the first panel portion 111.

The first panel portion 111 may form an outer shape of the installation panel 110, and the insertion hole 110a may be formed in the first panel portion 111 to allow the nozzle 22 to be inserted therethrough. In the first panel portion 111, the restraining portion 111a may be disposed at one end portion connected to the sliding panel 120. The restraining portion 111a may include a restraining protrusion 111b that protrudes downward. The restraining protrusion 111b of the restraining portion 111a may be partially inserted into and restrained in a locking groove 123b of the sliding panel 120, which will be described hereinafter. Accordingly, an operation of sliding the sliding panel 120 with respect to the installation panel 110 may be performed in a state in which the restraining protrusion 111b is separated from the locking groove 123b.

The sliding panel 120 may be slid in and out along a guide part or portion formed by partially bending upper and lower ends of the installation panel 110. The sliding panel 120 may include a plate-shaped second panel part or portion 121 having a predetermined width and a locking part or portion 122 formed inside of the second panel portion 121.

The second panel portion 121 may form an outer shape of the sliding panel 120. The sliding panel 120 may be slid in and out with respect to the installation panel 110, and a width of the second panel portion 121 may be smaller than a width of the first panel portion 111. The locking portion 122 may be formed inside of the second panel portion 121 to lock the locking protrusion 111b of the installation panel 110.

The locking portion 122 may be formed to correspond to a position of the restraining protrusion 111b of the installation panel 110. For example, the locking portion 122 may be formed in or at a central portion of the second panel portion 121. The locking portion 122 may include a plurality of locking protrusions 123a arranged in a longitudinal direction of the second panel part 121. The plurality of locking protrusions 123a may be spaced apart from each other, and locking groove 123b may be formed between neighboring locking protrusions 123a. As described above, the locking protrusion 111b of the installation panel 110 may be partially inserted into the locking groove 123b and locked.

Through the above structure, a user may adjust the length of the first installation member 100 to a desired size. For example, in a state in which the restraining protrusion 111b of the installation panel 110 is separated from the locking groove 123b of the sliding panel 120, the sliding panel 120 may be slid in and out with respect to the installation panel 110. With this structure, the length of the first installation member 100 may be set to the desired size, and then the restraining protrusion 111b of the installation panel 110 may be locked and restrained in the locking groove 123b of the sliding panel 120 and fixed to a set size.

FIG. 6 is a perspective view of a second installation member and third installation member of the window kit of the air conditioner according to an embodiment. Referring to FIG. 6, the second installation member 200 and the third installation member 300 of the window kit 2 of the air conditioner according to an embodiment may have structure that is symmetrical to each other. Herein, description is based on the second installation member 200, but the contents may be equally applied to the third installation member 300 symmetrically.

The second installation member 200 may include a base part or portion 210, a fixing part or portion 220 that fixes the base portion 210 to one end portion of the first installation member 100, and a variable part or portion 230 detachably connected to the base portion 210. The base portion 210 may include a fixed base part or portion 210a fixed to the second window frame rib 31e and a shielding base part or portion 210b that shields an open area between the side end portion 32c and the third frame portion 31c.

The fixed base portion 210a may have a shape corresponding to the second window frame rib 31e. The fixed base portion 210a may have a flat bar shape extending in one direction. For example, the fixed base portion 210a may be disposed on an inner surface of the second window frame rib 31e and fixed by the fastening member 201. A fastening hole 210h through which the fastening member 201 may pass may be formed on one surface of the fixed base portion 210a. For example, the fastening hole 210h may be formed at upper and lower end portions of the fixed base portion 210a; however, embodiments are not limited thereto.

The shielding base portion 210b may be formed by bending the fixed base portion 210a from an inner end to the outside. The shielding base portion 210b may have a shape corresponding to the open area between the side end portion 32c and the third frame portion 31c. The window kit 2 of the air conditioner according to an embodiment may be applied to a casement window, and thus, may have a right triangle flat shape of the shielding base portion 210b. For example, in the flat shape of the shielding base portion 210b, a side perpendicular to the base may be a corner portion in contact with the fixed base portion 210a.

A fixing part or portion 220 may be provided on an inner surface of the shielding base portion 210b. The fixing portion 220 may be provided to couple the first installation member 100 and the second installation member 200. The fixing portion 220 may protrude inward from the inner surface of the shielding base portion 210b. The fixing portion 220 may include a first fixing rib 221, and a second fixing rib 222 spaced downward from the first fixing rib 221. A groove into which the first installation member 100 may be partially inserted may be formed between the first fixing rib 221 and the second fixing rib 222. For example, one end portion of the installation panel 110 of the first installation member 100 may be partially inserted into and fixed to a groove formed between the first fixing rib 221 and the second fixing rib 222.

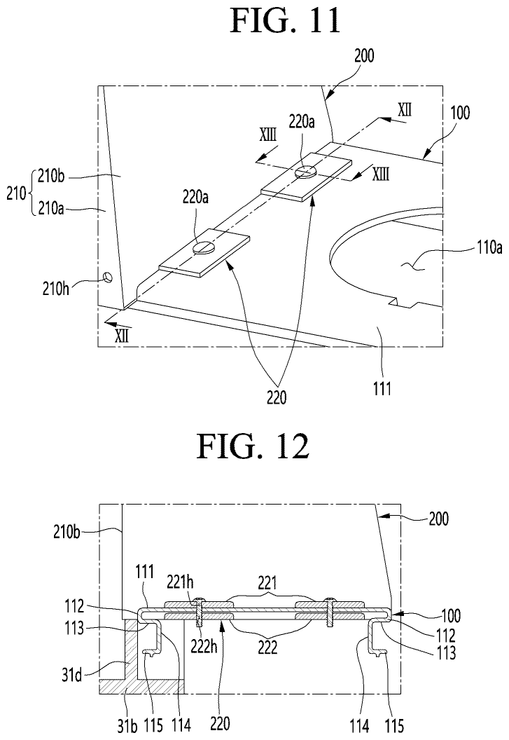

A coupling structure of the first installation member 100 and the second installation member 200 through the fixing portion 220 will be described hereinafter with reference to FIGS. 11 to 13.

A detachable variable part or portion 230 may be disposed on an upper side of the base portion 210. A plurality of variable parts or portions 230 may be provided and each variable portion 230 may be formed to be partially separable. The second installation member 200 in a state in which the base portion 210 and the variable portion 230 are connected may shield the open area between the side end portion 32c and the third frame portion 31c. Accordingly, a size of the second installation member 200 according to an embodiment may be changed to match a vertical size of the window frame 31 and the window 32. In other words, the second installation member 200 according to an embodiment may be universally applied to window frames 31 and windows 32 of various sizes.

Hereinafter, as an example, structure of the second installation member 200 including 10 variable portions 230 will be described.

A first variable part or portion 231 may be disposed at an upper end of the base portion 210 with a first cutout part or portion 2311 interposed therebetween. Along the first cutout portion 231I, the base portion 210 and the first variable portion 231 may be partially coupled. In other words, the base portion 210 and the first variable portion 231 may be partially separated along the first cutout portion 231I. Accordingly, the first variable portion 231 and the base portion 210 may be easily separated along the first cutout portion 231I. For example, when an external force is applied along the first cutout portion 231I or cut with a cutting tool, the base portion 210 and the first variable portion 231 may be easily separated. Description of the first cutout portion 231I may be equally applied to the second to tenth cutout portions 232I to 240I described hereinafter.

The first variable portion 231 may include a first fixed variable part or portion 231a disposed above the fixed base portion 210a and a first shielded variable part or portion 231b disposed above the shielding base portion 210b. The first fixed variable portion 231a may have a shape corresponding to the second window frame rib 31e in a state of being connected to the fixed base portion 210a. The first fixed variable portion 231a may have a flat bar shape extending in one direction. The first fixed variable portion 231a may have a first height h1.

The first fixed variable portion 231a may be disposed on an inner surface of the second window frame rib 31e and fixed by the fastening member 201. A first fastening hole 231h through which the fastening member 201 may pass may be formed on one surface of the first fixed variable portion 231a.

The first shielding variable portion 231b may be formed by bending the first fixed variable portion 231a from an inner end to the outside. The first shielding variable portion 231b may have a shape corresponding to the open area between the side end portion 32c and the third frame portion 31c in a state of being connected to the shielding base portion 210b.

The second variable portion 232 may be disposed on an upper end of the first variable portion 231 with the second cutout portion 232I interposed therebetween. The second variable portion 232 and the first variable portion 231 may be easily separated along the second cutout portion 232I. The second variable portion 232 may include a second fixed variable part or portion 232a disposed above the first fixed variable portion 231a and a second shielding variable part or portion 232b disposed above the first shielding variable portion 231b.

The second fixed variable portion 232a may have a second height h2. A second fastening hole 232h through which the fastening member 201 may pass may be formed on one surface of the second fixed variable portion 232a.

A third variable part or portion 233 may be disposed on an upper end of the second variable portion 232 with a third cutout part or portion 233I interposed therebetween. The third variable portion 233 may include a third fixed variable part or portion 233a disposed above the second fixed variable portion 232a and a third shielding variable part or portion 233b disposed above the second shielding variable portion 232b. The third fixed variable portion 233a may have a third height h3. A third fastening hole 233h through which the fastening member 201 may pass may be formed on one surface of the third fixed variable portion 233a.

Fourth to tenth variable portions 234 to 240 may be disposed at an upper end of the third variable portion 233 with fourth to tenth cutout portions 234I to 240I interposed therebetween. Each of the fourth to tenth variable portions 234 to 240 may include the fourth to tenth fixed variable portions 234a to 240a disposed above the third fixed variable portion 233a, and fourth to tenth shielding variable portions 234b to 204b disposed on an upper side of the third shielding variable portion 233b. Each of the fourth to tenth fixed variable portions 234a to 240a may have a fourth to tenth height h4 to h10. For example, the first to tenth heights h1 to h10 of the first to tenth fixed variable portions 231a to 240a may be set to be the same; however, embodiments are not limited to this and may be set in various ways. Fourth to tenth fastening holes 234h to 240h through which the fastening member 201 may pass may be formed on one surface of the fourth to tenth fixed variable portions 234a to 240a.

In addition, description of the second to tenth fixed variable portions 232a to 240a and the second to tenth shielding variable portions 232b to 240b have been omitted as the description may be applied in the same way as the description of the first fixed variable portion 231a and the first shielding variable portion 231b.

The second installation member 200 may include a front portion 200a including a fixed base part or portion 210a and first to tenth fixed variable parts or portions 231a to 240a and a side portion 200b including a shielding base part or portion 210b and first to tenth shielding variable parts or portions 231b to 240b.

The window kit 2 for an air conditioner according to an embodiment may further include a first support member 250 that fixes the second installation member 200. The first support member 250 may have a plate shape that has a predetermined width and extends in a direction in which the second installation member 200 extends.

The first support member 250 may include a base support part or portion 251 and a plurality of variable support parts or portions 252 connected to an upper end of the base support portion 251. A support member cutout part or portion 250I may be formed between the base support portion 251 and the variable support portion 252. With this structure, the plurality of variable support portions 252 may be easily separated from the base support portion 251.

Additionally, the support member cutout portion 250I may also be formed between each of the plurality of variable support portions 252. Accordingly, each of the plurality of variable support portions 252 may be easily separated from each other.

A length of the first support member 250 may be set in various ways by separating the plurality of variable support portions 252. The length of the first support member 250 may be set to correspond to a length of the second installation member 200.

The first support member 250 may be disposed opposite to the fixed base portion 210a and the first to tenth fixed variable portions 231a to 240a. The first support member 250 may include a support member fastening hole 250h for fixing the second installation member 200 to the second window frame rib 31e. The support member fastening hole 250h may be formed in each of the base support portion 251 and the plurality of variable support portions 252.

The third installation member 300 may include a base part or portion 310, a fixing part or portion 320 that fixes the base portion 310 to the end portion of the first installation member 100, and a variable part or portion 330 detachably connected to the base portion 310. The base portion 310 may include a fixed base part or portion 310a fixed to the second window frame rib 31e and a shielding base part or portion 310b that shields the open area between the side end portion 32c and the third frame portion 31c.

The fixed base portion 310a may have a shape corresponding to the second window frame rib 31e. The fixed base portion 310a may have a flat bar shape extending in one direction. For example, the fixed base portion 310a may be disposed on an inner surface of the second window frame rib 31e and fixed by the fastening member 301. A fastening hole 310h through which the fastening member 301 may pass may be formed on one surface of the fixed base portion 310a. For example, the fastening hole 310h may be formed at upper and lower ends of the fixed base portion 310a, respectively; however, embodiments are not limited thereto.

The shielding base portion 310b may be formed by bending on an inner end of the fixed base portion 310a outward. The shielding base portion 310b may have a shape corresponding to the open area between the side end portion 32c and the third frame portion 31c. The window kit 2 of the air conditioner according to an embodiment may be applied to a casement window, and the shielding base portion 310b may have a right-triangular flat plate shape. For example, in the flat shape of the shielding base portion 310b, a side perpendicular to the base may be a corner portion in contact with the fixed base portion 310a.

A fixing part or portion 320 may be provided on an inner surface of the shielding base portion 310b. The fixing portion 320 may be provided to couple the first installation member 100 and the third installation member 300. The fixing portion 320 may protrude inward from the inner surface of the shielding base portion 310b. The fixing portion 320 may include a first fixing rib 321, and a second fixing rib 322 spaced downward from the first fixing rib 321. A groove into which the first installation member 100 is partially inserted may be formed between the first fixing rib 321 and the second fixing rib 322. For example, one end portion of the sliding panel 120 of the first installation member 100 may be partially inserted into and fixed to a groove formed between the first fixing rib 321 and the second fixing rib 322.

A detachable variable part or portion 330 may be disposed on or at an upper side of the base portion 310. A plurality of variable parts or portions 330 may be provided and the variable portion 330 may be formed to be partially separable. The third installation member 300 in a state in which the base portion 310 and the variable portion 330 are connected may shield the open area between the side end portion 32c and the third frame portion 31c. Accordingly, the third installation member 300 according to an embodiment may be changed in size to match a vertical size of the window frame 31 and the window 32. In other words, the third installation member 300 according to an embodiment may be universally applied to window frames 31 and windows 32 of various sizes.

Hereinafter, structure of the third installation member 300 including 10 variable portions 330 will be described.

A first variable part or portion 331 may be disposed at an upper end of the base portion 310 with the first cutout portion 331I interposed therebetween. The first variable portion 331 and the base portion 310 may be easily separated along the first cutout portion 331I. The first variable portion 331 may include a first fixed variable part or portion 331a disposed above the fixed base portion 310a and a first shielded variable part or portion 331b disposed above the shielding base portion 310b.

The first fixed variable portion 331a may have a shape corresponding to the second window frame rib 31e in a state of being connected to the fixed base portion 310a. The first fixed variable portion 331a may have a flat bar shape extending in one direction. The first fixed variable portion 331a may have a first height h1.

The first fixed variable portion 331a may be disposed on an inner surface of the second window frame rib 31e and fixed by the fastening member 301. A first fastening hole 331h through which the fastening member 301 may pass may be formed on one surface of the first fixed variable portion 331a.

The first shielding variable portion 331b may be formed by bending the first fixed variable portion 331a from the inner end to the outside. The first shielding variable portion 331b may have a shape corresponding to the open area between the side end portion 32c and the third frame portion 31c in a state of being connected to the shielding base portion 310b.

A second variable part or portion 332 may be disposed on an upper end of the first variable portion 331 with a second cutout part 332I interposed therebetween. The second variable portion 332 and the first variable portion 331 may be easily separated along the second cutout portion 332I. The second variable portion 332 may include a second fixed variable part or portion 332a disposed above the first fixed variable portion 331a and a second shielding variable part or portion 332b disposed above the first shielding variable portion 331b.

The second fixed variable portion 332a may have a second height h2. A second fastening hole 332h through which the fastening member 301 may pass may be formed on one surface of the second fixed variable portion 332a.

Third to tenth variable parts or portions 333 to 340 may be disposed on an upper end of the second variable portion 332 with third to tenth cutout parts or portions 333I to 340I interposed therebetween. Each of the third to tenth variable portions 333 to 340 may include third to tenth fixed variable parts or portions 333a to 340a disposed above the third fixing variable portion 333a and third to tenth shielding variable parts or portions 333b to 204b disposed above the third shielding variable portion 333b. Each of the third to tenth fixed variable portions 333a to 340a may have a third to tenth height h4 to h10. For example, the first to tenth heights h1 to h10 of the first to tenth fixed variable portions 331a to 340a may be set to be the same; however, embodiments are not limited to this and may be set in various ways.

Third to tenth fastening holes 333h to 340h through which the fastening member 301 may pass may be formed on one surface of the third to tenth fixed variable parts 333a to 340a. In addition, description of the second to tenth fixed variable portions 332a to 340a and the second to tenth shielding variable portions 332b to 340b has been omitted as description may be applied in the same way as the explanation for the first fixing variable portion 331a and the first shielding variable portion 331b, respectively.

The window kit 2 of an air conditioner according to an embodiment may further include a second support member 350 that fixes the third installation member 300. The second support member 350 may have substantially a same structure as the second support member 250 described above. For example, the second support member 350 may have a predetermined width and a flat plate shape that extends in a direction in which the third installation member 300 extends.

The second support member 350 may include a base support part or portion 351 and a plurality of variable support parts or portions 352 connected to an upper end of the base support portion 351. A support member cutout part or portion 350I may be formed between the base support portion 351 and the variable support portion 352. With this structure, the plurality of variable support portions 352 may be easily separated from the base support portion 351.

Additionally, the support member cutout portion 350I may also be formed between each of the plurality of variable support portions 352. Accordingly, each of the plurality of variable support portions 352 may be easily separated from each other.

A length of the second support member 350 may be set in various ways by separating the plurality of variable support portions 352. The length of the second support member 350 may be set to correspond to a length of the third installation member 300.

The second support member 350 may be disposed opposite to the fixed base portion 310a and the first to tenth fixed variable portions 331a to 340a of the third installation member 300. The second support member 350 may include a support member fastening hole 350h for fixing the third installation member 300 to the second window frame rib 31e. The support member fastening hole 350h may be formed in each of the base support portion 351 and the plurality of variable support portions 352.

FIG. 7 is an enlarged perspective view of area A of FIG. 2 FIG. 8 is an enlarged perspective view of area B of FIG. 2.

Hereinafter, with reference to FIGS. 7 and 8, structure for fixing the first installation member 100 to the first window frame rib 31d and the rotating end portion 32b of the window 32 using the fixing member 400 will be described. Referring to FIGS. 7 and 8, the first fixing member 410 may include a first horizontal fixing part or portion 411 coupled to one or a first end of an upper surface of the first installation member 100 and a first vertical fixing part or portion 412 bent upward from one end portion of the first horizontal fixing portions 411.

The first horizontal fixing portion 411 may be fastened to the first installation member 100 by a fastening member 411a. A restraining member 430 may be rotatably coupled to the first vertical fixing portion 412.

The second fixing member 420 may include a second horizontal fixing part or portion 421 coupled to the other or a second end of the upper surface of the first installation member 100 and a second vertical fixing part or portion 422 bent upward from one end portion of the second horizontal fixing portion 421. For example, the second vertical fixing part 422 may include a fastening hole 422h, and a fastening member 422a that penetrates the fastening hole 422h and may be fastened to the rotating end portion 32b of the window 32.

A portion where the fastening member 422a is fastened to the rotating end portion 32b may be a portion where a handle of the existing window 32 is fastened. Accordingly, the first installation member 100 may be fixed without forming perforations in the rotating end portion 32b of the window 32.

The restraining member 430 may include a restraining member fixing part or portion 431 coupled to the first vertical fixing portion 412, a handle portion 432 connected to the restraining member fixing portion 431, a restraining member 433 that protrudes to one side from the handle portion 432, and a restraining member rotation part or portion 434 that connects the restraining member fixing portion 431 and the handle portion 432.

The restraining member fixing portion 431 may be fastened to and fixed to the first vertical fixing portion 412 by a fastening member 412a. The handle portion 432 may be rotatably coupled to the restraining member fixing portion 431 by the restraining member rotation portion 434. In other words, the restraining member rotation portion 434 may constitute a rotational axis of the handle portion 432.

The restraining portion 433 may be restrained or fixed to the first window frame rib 31d as the handle portion 432 rotates. For example, when the restraining portion 433 overlaps the first window frame rib 31d and the first window frame rib 31d is located between the restraining portion 433 and the first vertical fixing portion 412, the first installation member 100 may be fixed to the window frame 31. When the handle portion 432 rotates so that the restraining portion 433 does not overlap the first window frame rib 31d, a fixed state of the first installation member 100 to the window frame 31 may be released.

Through the above structure, the first installation member 100 may be easily fixed to the window frame 31 without causing additional damage, such as perforations, in the window frame 31. Therefore, when installing the window kit 2 of an air conditioner, it is possible to prevent an aesthetic sense of an outer appearance of the window frame 31 from being deteriorated.

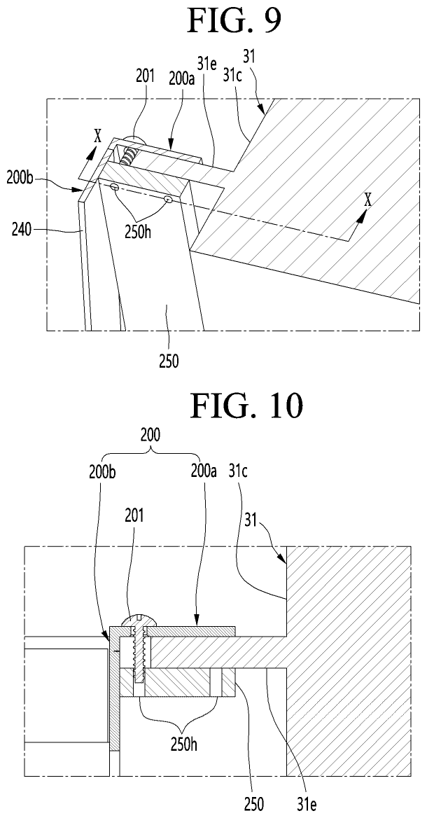

Hereinafter, with reference to FIGS. 9 and 10, structure for fixing the second installation member 200 to the second window frame rib 31e using the first support member 250 will be described.

FIG. 9 is a cross-sectional view taken along line IX-IX of FIG. 1. FIG. 10 is a cross-sectional view, taken along line X-X of FIG. 9.

Referring to FIGS. 9 and 10, the second installation member 200 according to an embodiment may be fixed to the second window frame rib 31e through the first support member 250 without perforations. For example, the front portion 200a of the second installation member 200 may be fixed on one or a first side of the second window frame rib 31e, and the first support member 250 may be fixed on the other or a second side thereof. The fastening member 201 may penetrate the front portion 200a of the second installation member 200 and the support member fastening hole 250h of the first support member 250. The fastening member 201 may avoid the second window frame rib 31e and may not penetrate. The fastening member 201 may be located outside of the end portion of the second window frame rib 31e. As the fastening holes 250h of the first support member 250 are formed on both sides, the first support member 250 may be used without distinction between the front surface and the rear surface.

In a state in which the fastening member 201 is fastened, the second window frame rib 31e may be located between the front portion 200a of the second installation member 200 and the first support member 250. In other words, the second window frame rib 31e may be partially inserted into a space between the front portion 200a of the second installation member 200 and the first support member 250. When the fastening member 201 is sufficiently tightened and fastened, through a binding force between the front portion 200a of the second installation member 200 and the first support member 250, the second installation member 200 may be fixed to the second window frame rib 31e.

A plurality of fastening members 201 that fastens the front portion 200a of the second installation member 200 and the first support member 250 may be provided along a longitudinal direction of the first support member 250. Accordingly, as the fastening member 201 is fastened at a plurality of positions, the second installation member 200 may be more strongly and stably fixed to the second window frame rib 31e.

Through the above structure, the second installation member 200 may be easily fixed to the window frame 31 without causing additional damage, such as perforations, in the window frame 31. Therefore, when installing the window kit 2 of an air conditioner, it is possible to prevent an aesthetic sense of the outer appearance of the window frame 31 from being deteriorated.

In the above, only the structure for fixing the second installation member 200 to the second window frame rib 31e using the first support member 250 has been described, but the above description may be equally applied to structure in which the third installation member 300, which has a symmetrical structure with the second installation member 200, is fixed to the second window frame rib 31e using the second support member 350.

Hereinafter, a coupling structure between the first installation member 100 and the second installation member 200 will be described with reference to FIGS. 11 to 13.

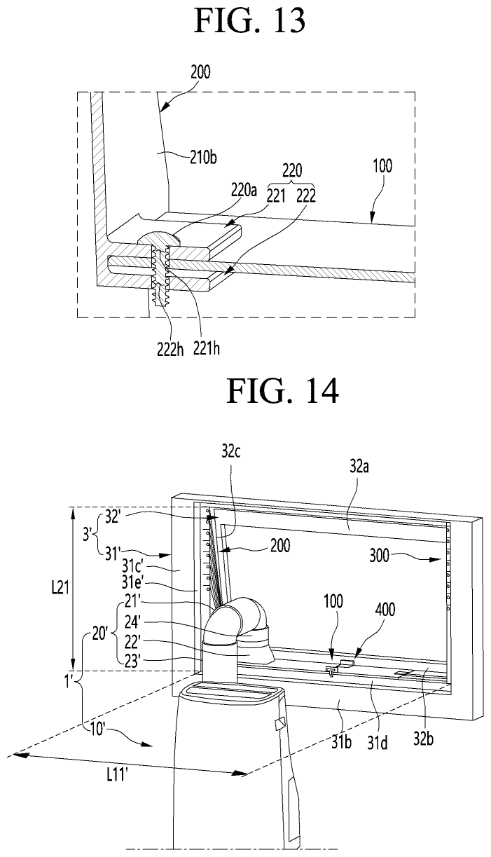

FIG. 11 is an enlarged perspective view of area C in FIG. 2. FIG. 12 is a cross-sectional view, taken along line XII-XII of FIG. 11. FIG. 13 is a cross-sectional view, taken along line XIII-XIII of FIG. 11.

Referring to FIGS. 11 to 13, one end portion of the first panel portion 111 of the first installation member 100 may be partially inserted in a groove formed between the first fixing rib 221 and the second fixing rib 222. The first fixing rib 221 may include a first fixing rib fastening hole 221h to which the fastening member 220a is fastened, and the second fixing rib 222 may include a second fixing rib fastening hole 222h to which the fastening member 220a is fastened.

For example, the installation panel 110 of the first installation member 100 may include a guide part or portion formed by bending downward from both end portions of the first panel portion 111. The guide portion may provide a path through which the sliding panel 120 is slid in and out. The guide portion may include a first vertical bent part or portion 112 bent downward from both end portions of the first panel portion 111, a first horizontal bent part or portion 113 bent inward from a lower end portion of the first vertical bent portion 112, a second vertical bent part or portion 114 bent downward from an inner end portion of the first horizontal bent portion 113, and a second horizontal bent part or portion 115 bent outward from a lower end portion of the second vertical bent portion 114.

The first vertical bent portion 112 may be supported by the first window frame rib 31d. For example, the first vertical bent portion 112 may be in contact with the first window frame rib 31d and may be easily aligned in a frontward and rearward direction when fixing the first installation member 100. In addition, as the first vertical bent portion 112 supports the first window frame rib 31d, even if the sliding panel 120 slides in and out along the guide portion of the installation panel 110, it is possible to prevent the sliding panel 120 from interfering with the first window frame rib 31d.

FIG. 14 is a view illustrating a modified window kit of an air conditioner according to an embodiment installed on a window of a different size from the window of FIG. 1. First window frame rib 31d′ and second window frame rib 31e′ included in window frame 31′ illustrated in FIG. 14 may have different lengths from the first window frame rib 31d and the second window frame rib 31e illustrated in FIGS. 1 to 3.

For example, the first window frame rib 31d′ of the window frame 31′ illustrated in FIG. 14 may have a third length L11′ smaller than the first length L11, and the second window frame rib 31e′ may have a fourth length L21′ smaller than the second length L21.

The window kit 2′ of the air conditioner in FIG. 14 may include first installation member 100′ and second and third installation members 200′ and 300′ whose lengths are adjustable. The first installation member 100′ may be formed by sliding the sliding panel 120 into and out of the installation panel 110 and then fixing it to correspond to the third length L11′. The second installation member 200′ may be formed to correspond to the fourth length L21′ by partially separating the plurality of variable portions 230. The structure for fixing the window kit 2′ of the air conditioner to the window frame 31 and the window 32 may be applied in the same manner as described above with reference to FIGS. 1 to 13.

In other words, according to the window kit 2 of the air conditioner according to an embodiment, exhaust guide means 20 may be fixed stably to casement window 3 through structure that directly fixes the window kit 2 to the window frame 31. According to the window kit 2 of the air conditioner according to an embodiment, a size is adjustable and may be installed on casement windows 3 of various sizes without being limited by the size of the casement window 3.

According to the window kit 2 of the air conditioner according to an embodiment, an open area is minimized through the window kit 2 structure that may entirely shield the open area in the casement window 3, thereby it is possible to prevent air discharged to the outside from being re-introduced into the room through the exhaust guide means 20.

According to the window kit 2 of an air conditioner according to an embodiment, the fixing member 400 for fixing the window kit 2 to the window 32 is located in a place in which it may be easily fixed in the room, the window kit 2 may be easily fixed to the casement window 3.

According to the window kit 2 of the air conditioner according to an embodiment, the window frame 31 may be fixed without damaging it, thereby preventing the aesthetic sense of the outer appearance of the window frame 31 from being deteriorated.

Hereinafter, a window kit of an air conditioner according to another embodiment will be described. In the following embodiment, description of the same or similar structure as the already described embodiment has been omitted or simplified, and differences mainly explained.

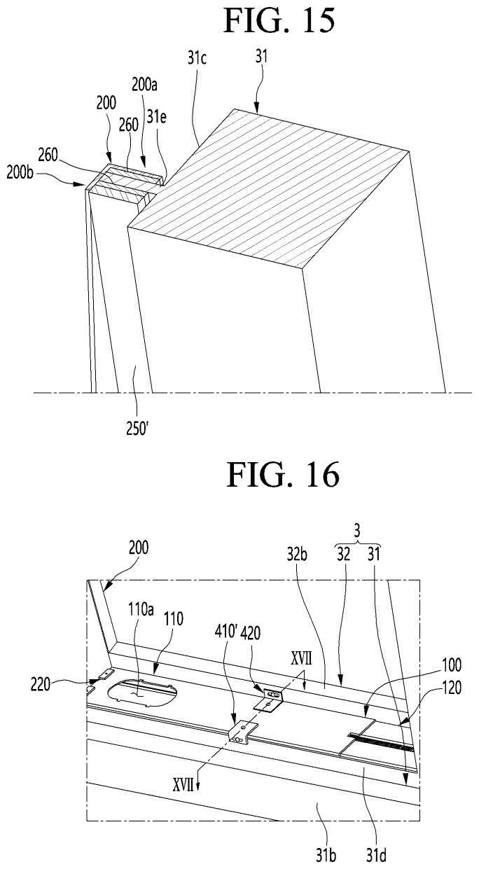

FIG. 15 is a view of a window kit for an air conditioner according to another embodiment. Referring to FIG. 15, window kit 2 of an air conditioner according to this embodiment is different from window kit 2 of an air conditioner according to other embodiments in that adhesive member 260 is applied as a fixing means for fixing when second installation member 200′ is fixed to second window frame rib 31e.

The adhesive member 260 may be disposed between a front portion 200a′ of the second installation member 200′ and the second window frame rib 31e. For example, the adhesive member 260 may be a material having an adhesive strength or a separate member having an adhesive strength on both sides, such as double-sided tape. In this embodiment, first support member 250′ and the second window frame rib 31e may also be provided with an adhesive member 260; however, embodiments are not limited to this, and the first support member 250′ may be omitted in some cases.

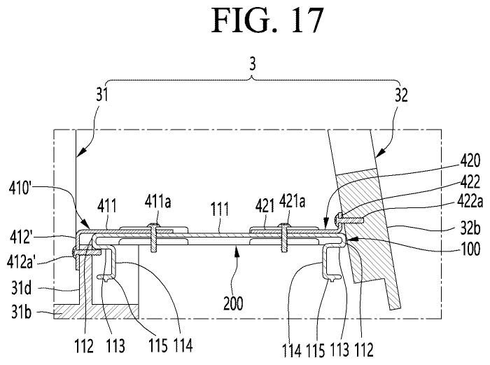

FIG. 16 is a view of a window kit for an air conditioner according to another embodiment. FIG. 17 is a cross-sectional view, taken along line XVII-XVII of FIG. 16.

Referring to FIGS. 16 and 17, window kit 2 of an air conditioner according to this embodiment is different from the window kit 2 of an air conditioner according to other embodiments in that restraining member 430 is omitted and first installation member 100 is fixed to the first window frame rib 31d by first fixing member 140′. The first fixing member 410′ may include a first horizontal fixing part or portion 411 coupled to one end of the upper surface of the first installation member 100, and a first vertical fixing part or portion 412′ bent downward from one end portion of the first horizontal fixing portion 411. The first vertical fixing portion 412′ may be fixed to the first window frame rib 31d by a fastening member 412a′. The first vertical bent portion 112 of the first installation member 100 may be supported on the first window frame rib 31d.

An end portion of the fastening member 412a′ fastened through the first vertical fixing portion 412′ and the first window frame rib 31d may support the first horizontal bent portion 113 upward. With this structure, the first installation member 100 may be more stably fixed to the first window frame rib 31d.

Embodiments disclosed herein provide a window kit for fixing an exhaust guide means of a mobile air conditioner to a casement window, in particular, a window kit that may be installed on a casement window.

Embodiments disclosed herein also provide a window kit for fixing an exhaust guide means of a mobile air conditioner that may be universally installed in casement windows of various sizes.

Embodiments disclosed herein further provide a window kit that may prevent air discharged to the outside through the exhaust guide means from re-entering a room by minimizing an open area in the casement window to which the exhaust guide means of the mobile air conditioner is fixed.

Embodiments disclosed herein furthermore provide a window kit for fixing an exhaust guide means of a mobile air conditioner that may be easily fixed to a casement window.

Embodiments disclosed herein additionally provide a window kit for fixing an exhaust guide means of a mobile air conditioner that may be fixed to a window frame without damaging the window frame.

A window kit of an air conditioner according to an embodiment, which is mounted on a window frame connected to a casement window and is coupled with an exhaust guide extending from an exhaust port of a mobile air conditioner, may include a first installation member mounted between a rotating end portion of the casement window and the window frame and including an insertion hole into which a nozzle of the exhaust guide is inserted, and a second installation member coupled to one end portion of the first installation member and mounted on the window frame, in which the first installation member is configured to have a variable length. The second installation member may include a base part or portion coupled to the first installation member, and a plurality of variable parts or portions detachably connected to an upper end of the base part.

The first installation member may include an installation panel mounted on the rotating end portion of the window and the window frame, and a sliding panel connected to the installation panel so as to slide in and out. The sliding panel may include a plurality of locking protrusions arranged in one direction, and a locking groove may be formed between neighboring locking protrusions of the plurality of locking protrusions. The installation panel may include a restraining protrusion inserted into the locking groove and configured to set a length of the first installation member.

The window frame may include a first window frame rib on which the first installation member may be mounted and which extends in one direction, and a second window frame rib which extends in a direction intersecting the first window frame rib and on which the second installation member may be mounted. The window kit of an air conditioner may further include a support member disposed to face one or a first surface of the second window frame rib. The second installation member may include a front portion facing the other or a second surface of the second window frame rib, and a side portion bent from one end of the front portion. The front portion and the support member may be coupled to each other by a fastening member.

The second window frame rib may be disposed between the front portion and the support member. The fastening member may be disposed on or at an outside of the second window frame rib.

The base part may include a fixed base part or portion that faces one or a first surface of the second window frame rib, and a shielding base part or portion bent from one end of the fixed base part. The variable part may include a fixed variable part or portion connected to an upper end of the fixed base part and facing the one surface of the second window frame rib, and a shielding variable part or portion connected to an upper end of the shielding base part and bent from one end of the fixed variable part.

The second installation member may include a first cutout part or portion disposed between the fixed base part and the fixed variable part, partially coupled, and thus formed to facilitate separation. The second installation member may include a second cutout part or portion disposed between the shielding base part and the shielding variable part, partially coupled, and thus formed to facilitate separation. The second cutout part may be connected to the first cutout part.

The window kit of an air conditioner may further include a first fixing member coupled to an upper surface of the first installation member, and a restraining member rotatably connected to the first fixing member and configured to be restrained by the first window frame rib as rotating. The first fixing member may include a horizontal fixing part or portion coupled to the upper surface of the first installation member, and a vertical fixing part or portion bent upward from one end portion of the horizontal fixing part. The restraining member may be coupled to the vertical fixing part.

The restraining member may include a handle portion connected to the vertical fixing part and configured to rotate, and a restraining portion configured to overlap or not overlap the first window frame rib according to rotation of the handle portion. When the restraining portion and the first window frame rib overlap, the restraining member may restrain so that the first installation member is fixed to the first window frame rib.

The second installation member may include a front portion that faces one surface of the second window frame rib, and a side portion bent from one end of the front portion. An adhesive member may be disposed between the front portion and the second window frame rib.

The casement window may further include a fixed end portion that forms a rotational axis of the rotation end portion, and a side end portion that connects the rotating end portion and the fixed end portion. The second installation member may shield an area between the side end portion and the second window frame rib, and the first installation member may shield an area between the rotating end portion and the first window frame rib.

An inner end portion of the first installation member may be supported by the first window frame rib.

The second installation member may further include a fixing part or portion that protrudes from the inner surface of the base part. The fixing part may include a first fixing rib, and a second fixing rib spaced below the first fixing rib. The first installation member may be partially inserted into a groove formed between the first fixing rib and the second fixing rib.

The second installation member may include a first cutout part or portion disposed between the base part and the plurality of variable parts, partially coupled, and thus formed to facilitate separation. The second installation member may further include a second cutout part or portion disposed between adjacent variable parts of the plurality of variable parts, partially coupled, and thus formed to facilitate separation.

At least the following advantages may be expected from the window kit of an air conditioner according to the embodiment.

According to the window kit of an air conditioner according to an embodiment, the exhaust guide means may be stably fixed to the casement window through structure in which the window kit is directly fixed to the window frame.

According to the window kit for an air conditioner according to an embodiment, a size is adjustable and may be installed on casement windows of various sizes without being limited by the size of the casement window.

According to the window kit of an air conditioner according to an embodiment, an open area is minimized through a window kit structure that may entirely shield the open area in the casement window, and thus the air discharged to the outside through the exhaust guide means may be prevented from re-entering the room.

According to the window kit of the air conditioner according to the embodiment, the fixing means for fixing the window kit to the window is located in a place in which it can be easily fixed in the room, so the window kit may be easily fixed to the casement window.

According to the window kit for an air conditioner according to an embodiment, it can be fixed to the window frame without damaging the window frame, thereby preventing aesthetics of an outer appearance of the window frame from being deteriorated.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A window kit of an air conditioner, which is configured to be mounted on a window frame connected to a casement window and coupled with an exhaust guide that extends from an exhaust port of a mobile air conditioner, the window kit comprising:
a first installation member configured to be mounted between a rotating end portion of the casement window and the window frame and including an insertion hole into which a nozzle of the exhaust guide is inserted; and
a second installation member coupled to one end portion of the first installation member and mounted on the window frame, wherein the first installation member is configured to have a variable length, and wherein the second installation member includes:
a base portion coupled to the first installation member; and
a plurality of variable portions detachably connected to an upper end of the base portion.

2. The window kit of claim 1, wherein the first installation member includes:
an installation panel configured to be mounted on the rotating end portion of the casement window and on the window frame; and
a sliding panel connected to the installation panel so as to slide in and out.

3. The window kit of claim 2, wherein the sliding panel includes a plurality of locking protrusions arranged in one direction, wherein a locking groove is formed between neighboring locking protrusions of the plurality of locking protrusions, and wherein the installation panel includes a restraining protrusion inserted into the locking groove and configured to set a length of the first installation member.

4. The window kit of claim 1, wherein the window frame includes:
a first window frame rib on which the first installation member is configured to be mounted and which extends in one direction; and
a second window frame rib that extends in a direction intersecting the first window frame rib and on which the second installation member is configured to be mounted.

5. The window kit of claim 4, further comprising:
a support member disposed to face a first surface of the second window frame rib, wherein the second installation member includes:
a front portion that faces a second surface of the second window frame rib; and
a side portion bent from one end of the front portion, and wherein the front portion and the support member are coupled to each other by a fastening member.

6. The window kit of claim 5, wherein the second window frame rib is disposed between the front portion of the second installation member and the support member, and wherein the fastening member is disposed at an outside of the second window frame rib.

7. The window kit of claim 4, wherein the base portion includes:
a fixed base portion that faces the first surface of the second window frame rib; and
a shielding base portion bent from one end of the fixed base portion, and wherein the variable portion includes:
a fixed variable portion that is connected to an upper end of the fixed base portion and faces the first surface of the second window frame rib; and
a shielding variable portion connected to an upper end of the shielding base portion and bent from one end of the fixed variable portion.

8. The window kit of claim 7, wherein the second installation member further includes:
a first cutout portion disposed between the fixed base portion and the fixed variable portion, partially coupled, and thus formed to facilitate separation.

9. The window kit of claim 8, wherein the second installation member further includes:
a second cutout portion disposed between the shielding base portion and the shielding variable portion, partially coupled, and thus formed to facilitate separation, and wherein the second cutout portion is connected to the first cutout portion.

10. The window kit of claim 4, further comprising:
a first fixing member coupled to an upper surface of the first installation member; and
a restraining member rotatably connected to the first fixing member and configured to be restrained by the first window frame rib from rotating, wherein the first fixing member includes:
a horizontal fixing portion coupled to an upper surface of the first installation member; and
a vertical fixing portion bent upward from one end portion of the horizontal fixing portion, and wherein the restraining member is coupled to the vertical fixing portion.

11. The window kit of claim 10, wherein the restraining member includes:
a handle portion connected to the vertical fixing portion and configured to rotate; and
a restraining portion configured to overlap or not overlap the first window frame rib according to rotation of the handle portion.

12. The window kit of claim 11, wherein, when the restraining portion and the first window frame rib overlap, the restraining member is restrained so that the first installation member is fixed to the first window frame rib.

13. The window kit of claim 4, wherein the second installation member further includes:
a front portion that faces one surface of the second window frame rib; and
a side portion bent from one end of the front portion, and wherein an adhesive member is disposed between the front portion and the second window frame rib.

14. The window kit of claim 4, wherein the casement window further includes:
a fixed end portion that forms a rotational axis of the rotation end portion; and
a side end portion that connects the rotating end portion and the fixed end portion, wherein the second installation member shields an area between the side end portion and the second window frame rib, and wherein the first installation member shields an area between the rotating end portion and the first window frame rib.

15. The window kit of claim 4, wherein an inner end portion of the first installation member is supported by the first window frame rib.

16. The window kit of claim 1, wherein the second installation member further includes a fixing portion that protrudes from an inner surface of the base portion, wherein the fixing portion includes:
a first fixing rib; and
a second fixing rib spaced below the first fixing rib, and wherein the first installation member is partially inserted into a groove formed between the first fixing rib and the second fixing rib.

17. The window kit of claim 1, wherein the second installation member includes:
a first cutout portion disposed between the base portion and the plurality of variable portions, partially coupled, and thus formed to facilitate separation.

18. The window kit of claim 17, wherein the second installation member further includes a second cutout portion disposed between adjacent variable portions of the plurality of variable portions, partially coupled, and thus formed to facilitate separation.

19. An air conditioner comprising the window kit of claim 1.

20. A window kit of an air conditioner, which is configured to be mounted on a window frame connected to a casement window and coupled with an exhaust guide that extends from an exhaust port of a mobile air conditioner, the window kit comprising:
a first installation member configured to be mounted between the casement window and the window frame and including an insertion hole into which a nozzle of the exhaust guide is inserted, the first installation member including an installation panel configured to be mounted on the casement window and the window frame, and a sliding panel configured to slide with respect to the installation panel to adjust a length of the first installation panel; and
a second installation member coupled to one end portion of the first installation member and mounted on the window frame, the second installation member including a base portion coupled to the first installation member, and a plurality of variable portions detachably connected to an upper end of the base portion.

21. The window kit of claim 20, wherein the second installation member includes:
a first cutout portion disposed between the base portion and the plurality of variable portions, partially coupled, and thus formed to facilitate separation, wherein the second installation member further includes a second cutout portion disposed between adjacent variable portions of the plurality of variable portions, partially coupled, and thus formed to facilitate separation.

22. An air conditioner comprising the window kit of claim 20.
